(19) United States
(12) Patent Application Publication
(10) Pub. No.: US 2014/0040161 A1
(43) Pub. Date: Feb. 6, 2014

(54) METHOD AND SYSTEM FOR MANAGING BUSINESS FEEDBACK ONLINE

(71) Applicant: Jason Berlin, Syosset, NY (US)

(72) Inventor: Jason Berlin, Syosset, NY (US)

(21) Appl. No.: 13/946,915

(22) Filed: Jul. 19, 2013

Related U.S. Application Data
(60) Provisional application No. 61/678,200, filed on Aug. 1, 2012.

(51) Int. Cl. G06Q 30/02

(52) U.S. Cl. CPC G06Q 30/0282
USPC 705/347

(57) ABSTRACT

A method and system for a business to manage negative feedback reviews submitted on a public review webpage by a customer. The method includes registering with a review management service, assigning a unique identifier and a profile page to the business, encouraging a customer to submit a review of the business using the unique identifier, and providing, to the business, information from the review management service which enables the business to counter or manage negative reviews. Thereby, a business can be notified when a negative feedback review is submitted by a customer prior to the negative feedback review being submitted to a public review webpage. The method also includes enabling businesses to receive notification of feedback for individual employees to take appropriate corrective action. Further, the business can provide customers with rewards as an incentive or encouragement to complete reviews with the goal of obtaining positive reviews from satisfied customers.

### COPYRIGHT NOTICE

The present application includes material that is subject to copyright protection. The copyright owner does not object to the facsimile reproduction of the application by any person as the application appears in the records of the U.S. Patent and Trademark Office, but otherwise reserves all rights in the copyright.

### BACKGROUND

Currently, it is relatively easy for a customer to review a business through many different review webpages, but it is not as easy for the business to keep track of each and every review submitted by customers. Many reviews that are submitted by customers are negative in nature as the customer is often angry and desires to vent his or her frustration with the company or its products due to a bad experience. Positive reviews are not as easily provided as satisfied customers do not feel the need to share their feelings with others. It would be very beneficial for a business, especially a smaller business, to be aware of and be able to manage customer reviews whether the reviews are positive or negative.

Due to the potential damage that negative reviews can cause a business, there are companies who prey on the fact that a business might be unaware of negative online reviews that tarnish their reputation. The preying companies take advantage of the inability of most businesses to manage negative reviews submitted by customers. These companies essentially charge fees for the smaller businesses to manage their reviews with a specific goal of trying to resolve negative reviews. There currently is not a service that allows a business to manage the negative reviews themselves or to encourage satisfied customers to submit positive reviews.

Therefore, there is a need for a system and method that allows for a business to manage both negative and positive feedback reviews submitted on public review webpages by customers. The present invention now satisfies that need.

### SUMMARY OF THE INVENTION

In accordance with the principles of the present invention, systems and methods for a business to manage negative feedback reviews submitted on a public review webpage by a customer are provided. The method includes the steps of registering a business with a review management service; assigning a unique identifier to the business, where the unique identifier is associated with a business profile webpage provided by the review management service; submitting, by a customer, the unique identifier within a webpage provided by the review management service; after receiving the unique identifier, redirecting the customer to a profile webpage unique to the business associated with the submitted unique identifier; submitting, by the customer, a feedback review for the business; and in response to receiving the feedback review from the customer, providing, to the business, information relating to the customer feedback from the review management service which enables the business to counter or manage the negative feedback.

The invention also relates to a system for enabling a business to manage negative feedback reviews submitted on a public review webpage by a customer, with the system comprising a review management service that includes an interface component and a server, wherein the review management service is configured to electronically perform the method steps described herein.

Also, the invention relates to a non-transitory processor readable medium for enabling a business to manage negative feedback reviews submitted on a public review webpage by a customer, the medium comprising instructions that when executed by a processor causes the processor to perform actions that comprise the method steps described herein.

### BRIEF DESCRIPTION OF THE DRAWINGS

Features of embodiments of the invention, its nature, and various advantages will be apparent from the following detailed description, taken in conjunction with the accompanying drawings in which:

FIG. 1 illustrates an exemplary process for a business to manage negative feedback reviews submitted on a public webpage by a customer in accordance with embodiments of the invention;

FIG. 2 illustrates an exemplary process for a business to manage the performance different entities within a business in accordance with embodiments of the invention;

FIG. 3 illustrates an exemplary process for a business to provide incentives to customers to promote positive feedback reviews in accordance with embodiments of the invention;

FIG. 4 illustrates an exemplary process for a business to provide incentives to customers to promote positive feedback reviews in accordance with embodiments of the invention;

FIG. 5 illustrates an exemplary feedback review management system in accordance with embodiments of the invention;

FIG. 6 is an exemplary screenshot of the webpage provided by the review management service in accordance with embodiments of the invention;

FIG. 7 is an exemplary screenshot of a business profile page in accordance with embodiments of the invention;

FIG. 8 is an exemplary screenshot for a business profile including area for a customer to provide a feedback review in accordance with embodiments of the invention;

FIG. 9 is an exemplary screenshot of a form to provide comments or suggestions to a business in accordance with embodiments of the invention;

FIG. 10 is an exemplary screenshot for a customer to provide a feedback review inside of a frame with targeted review webpages in accordance with embodiments of the invention; and

FIG. 11 is an exemplary screenshot of a form to provide a customer the opportunity to receive future communication in accordance with embodiments of the invention.

### DETAILED DESCRIPTION OF THE INVENTION

As noted, negative feedback can cause harm to a business so it is in the best interests of the business to become apprised of such reviews relatively quickly on that corrective action can be taken. Also, positive reviews are less likely to be made, so businesses need a way to encourage satisfied customers to provide positive feedback in order to provide a more fair view of the business. Obviously, a business with hundreds of good reviews and some negative reviews will be viewed in a much better light than one that has multiple negative reviews and few or no positive ones.

The invention is primarily directed towards managing negative feedback reviews submitted on a public review webpage by a customer although it can also be used to encourage customers to provide positive reviews. For example, the business could provide customer incentives for reviewing or completing a surveys about their experience with the business. As an encouragement to report on a positive experience, the business can reward the customer with a discount, coupon, etc. The customer should be desirous of obtaining such a benefit due to their satisfaction with their prior experience. The greater amount of reviews submitted also gives the business more information about how it is performing or viewed by its customers.

In the present method, the business first is registered with a review management service and a unique identifier is allocated to the business. The unique identifier is associated with a business profile webpage provided by the review management service. The customers utilize the unique identifier to access a webpage or website that relates to the business and that is provided by the review management service. After receiving the unique identifier, the customer is redirected to the webpage or website where a feedback review for the business or other comments can be submitted. The review management service then is able to provide the business with information or summaries of the reviews so that the business can take steps to appropriately counter or manage any negative feedback.

The information that is typically provided by review management service can be used by the business to address issues that are raised or to encourage other customers who have had good experiences to submit positive reviews. These additional reviews can be encouraged by providing a reward to a customer that provides a positive review. When receiving information relating to negative feedback, the business can take relatively quick steps to address the negative comments or to make corrections or improvements to avoid such negative comments in the future.

In this method, the information provided to the company can be a notification of the negative feedback review prior to being submitted to a public review webpage. This can alert the business to a potential problem to take action earlier than later to prevent further negative reviews, or even to allow subsequent customers to submit positive reviews that note that prior reports are no longer accurate and that previously mentioned problems have been resolved

As explained herein, the information that is provided can be attributed to a specific entity or employee of the company so that the business can take the necessary steps to re-train the employee or in a more drastic action, terminate or replace the employee to thus counter and prevent identifying, by the business, at least one or more entities within the business; assigning a unique entity identifier for at least each of the one or more identified entities within the business; submitting, by the customer, the unique entity identifier within the webpage provided by the review management service; after receiving the unique entity identifier, redirecting the customer to a profile webpage unique to an entity within the business associated with the submitted unique entity identifier; submitting, by the customer, a feedback review specific to the identified entity within the business; and receiving, by the business, notification of the feedback review specific to the identified entity to evaluate different entities within the business.

An alternative to directing customers to a review management service's website is for the business to direct the customer to the webpage of the business. From there they can accomplish the same exact features and tasks, but directly through the webpage of the business. This might help save the customer a step and therefore, more likely that a customer will provide a feedback review. This alternative is a white label option that can help with incentives and increase feedback reviews significantly. The review management service might provide additional help, such as designing the business' own review landing page, to reports and ranking analytics. The benefit of a white label option is that to a customer, it would provide a seamless approach to providing customer feedback reviews.

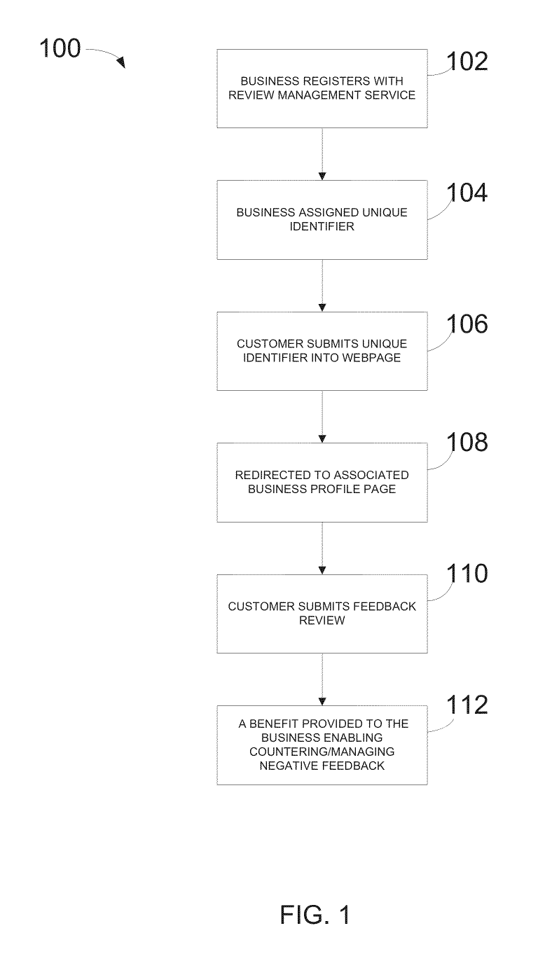

Turning now to the drawings, FIG. 1 illustrates an exemplary process for a business to manage negative feedback reviews on a public webpage, according to one embodiment of the present invention. At step 102, a business registers with a review management service. The review management service may provide any number of services to a business to help manage a businesses' online presence, such as feedback reviews. Then, the business is assigned a unique identifier by the review management service, at step 104. The unique identifier may be any combination of alphanumeric characters that uniquely identifies a business. A business may provide the unique identifier to customers, clients, etc., to provide the opportunity to submit feedback about the business. It should be appreciated that there are many different methods in which a business may provide customers or clients the unique identifier. For example, the business may include the unique identifier on a coupon, advertisement, email, social media, webpage, newsletter, QR (quick response) code, flyer, poster, etc. The customer may receive a URL that directs the customer to a webpage provided by the review management service.

Within the review management service's webpage, there is a place for the customer to submit the unique identifier provided by the business (106). The customer is then redirected to a business profile page associated with the unique identifier, at step 108. The unique identifier is uniquely associated with the business and therefore, associated with the corresponding business profile page. The review management service may keep records of each unique identifier or unique entity identifier to provide the business with statistics. The statistics may include how many customers submitted the unique identifier, how many customers left a review, number of positive review, number of negative reviews, number of customers who sign up to receive further communication, etc.

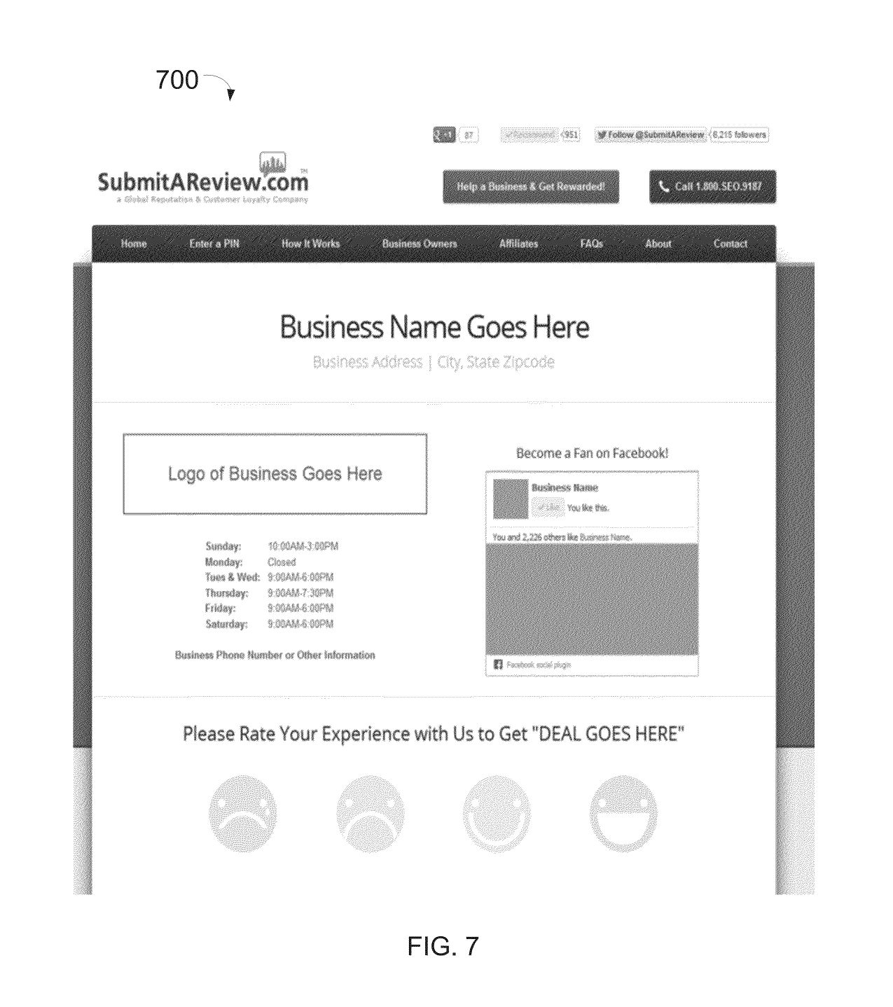

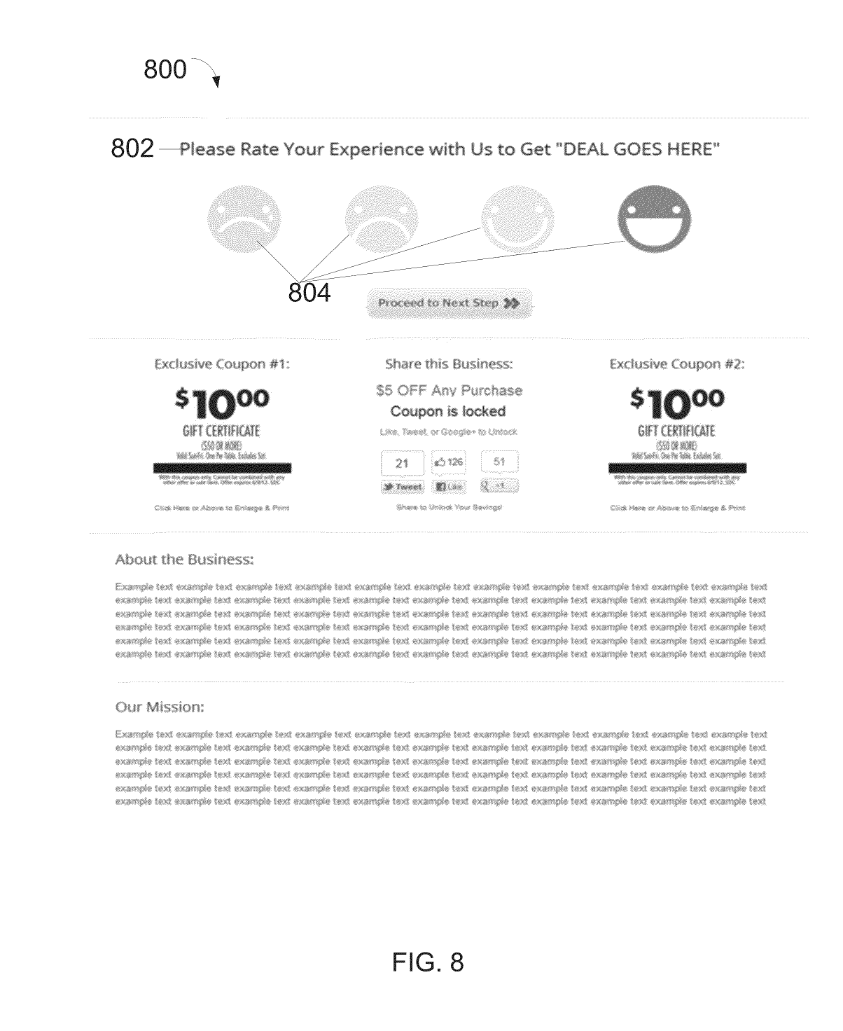

The business profile page allows a customer to either leave a positive feedback review or a negative feedback review. The business profile page may also include information about the business. See FIGS. 7 and 8 for more detail on this embodiment.

At step 110, the customer submits a feedback review. At step 112, information is provided to the business enabling the business to counter or manage negative feedback reviews. The countering of a negative feedback review may also include receiving, by the business, a notification of the negative feedback review prior to being submitted to a public review webpage. A business may choose to receive notification each and every time a feedback review is submitted (positive or negative). Each business may choose the way they would like to receive the notifications, such as email, text messages/SMS messages, etc.

To counter negative feedback, the business may also provide incentives or rewards to encourage satisfied customers to complete a positive review. The reward may also include, but is not limited to, a discount, coupon, etc. The reward can be provided after the customer provides further information to the business, such as by completing a survey or questionnaire.

The information provided to the business may also include providing feedback on a specific employee of the business. This situation may include the business identifying at least one or more entities or employees within the business which is described in further detail below.

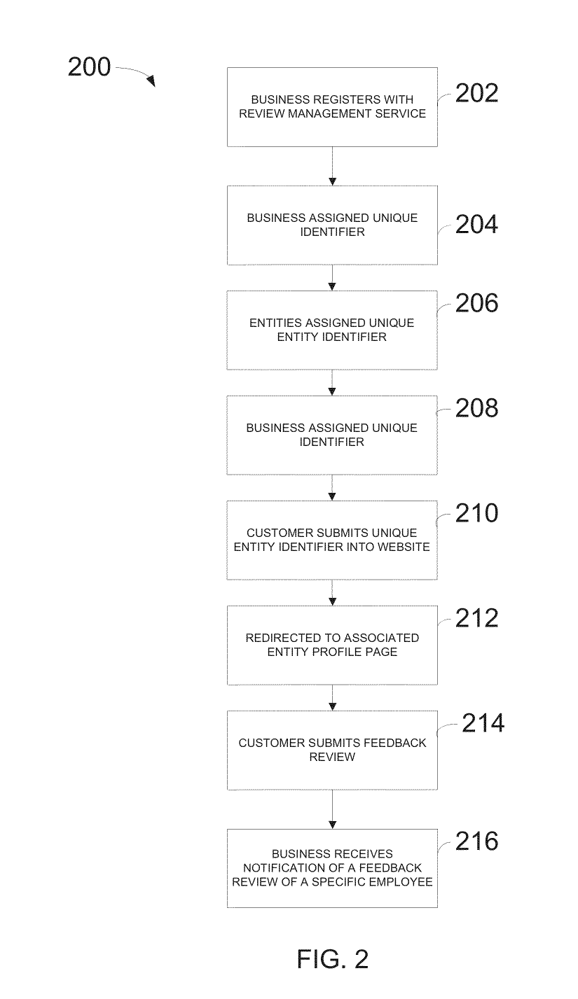

FIG. 2 illustrates an exemplary process for a business to manage the performance different entities within a business, in accordance with embodiments of the invention. At step 202, a business registers with the review management service which is described above. The business is assigned a unique identifier, at step 204, described above. At step 206, the business identifies one or more entities within the business to the review management service. Each identified entity is assigned a unique entity identifier that unique identifies that entity within the business, at step 208.

A customer submits the unique entity identifier within the webpage provided by the review management service, at step 210. After receiving the unique entity identifier, the review management service redirects the customer to a profile page unique to an entity within the business that is associated with the submitted unique entity identifier, at step 212. The customer submits a feedback review specific to the identified entity within the business, at step 214. The business then receives notification of the feedback review specific to the identified entity to evaluate different entities within the business, at step 216. Examples of different types of entities could be, but are not limited to, employees, teams, departments, locations, etc.

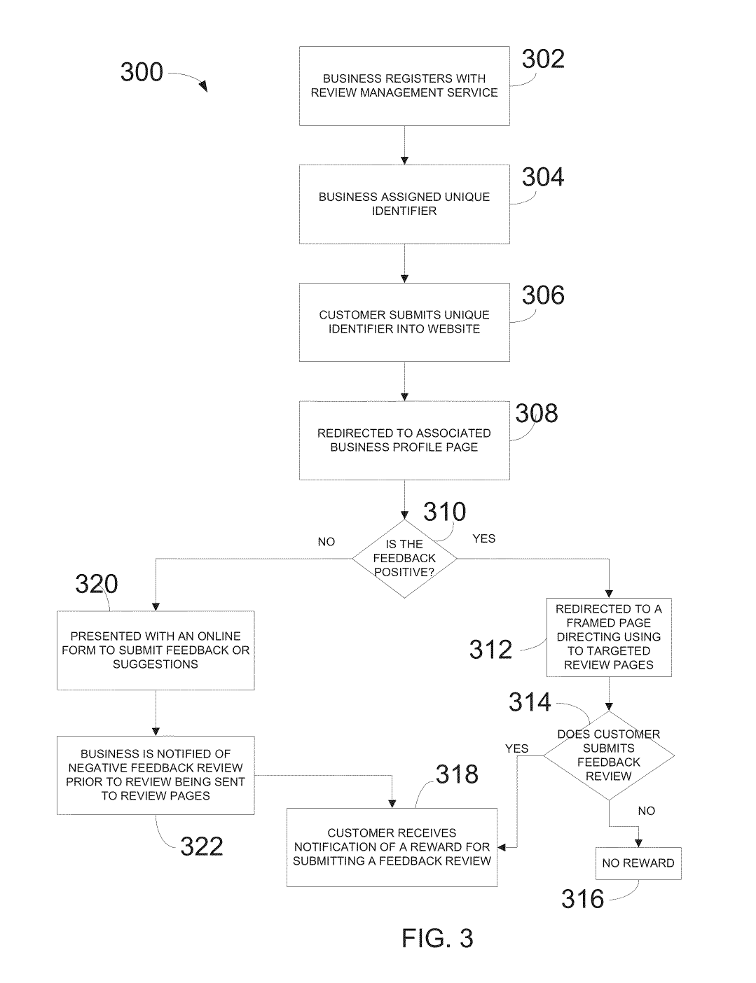

FIG. 3 illustrates an exemplary process for a business to provide incentives to customers to promote positive feedback reviews, in accordance with embodiments of the invention. The business registers with a review management service, at step 302. The business is then assigned a unique identifier, at step 304. The customer submits the unique identifier into the review management service's webpage, at step 306. The customer is then redirected to the associated business profile page, at step 308.

The review management service then determines if the feedback review is going to be positive or negative, at step 310. This step can be determined in many different methods. For example, the review management may simply ask the customer if the feedback review will be a positive or negative feedback review. Also, after a feedback review has been submitted, the review management service may then determine whether it was a negative or positive feedback review.

In the situation that the feedback review is positive, the customer is redirected to a page including targeted review pages, at step 312. The redirected page may be separate window or a frame within the original page. The targeted review pages may be selected based on information that the review management service has pertaining to the business. For example, if the business is a restaurant, one of the targeted review pages could be could be Yelp™ (www.yelp.com). The targeted review pages are online review webpages that are relevant to the type of business identified by the unique identifier.

Then it is determined if the customer submitted a feedback review with one of the targeted review webpages, at step 314. If it is determined that the customer did not submit a review, then the customer will not receive a reward (316), if it is determined that a customer does submit a review with one of the targeted review webpages, then the customer receives a notification of a reward (318). The notification the customer receives may be in many different forms, such as an email, a pop-up window, flyer in the mail, etc. When the customer submits a review, there may be an opportunity to gather personal information about the customer, such as email address, mailing address, phone number, birthday, age, name, social media information, etc. The review management service may also require that the customer enter the unique identifier or unique entity identifier in order to receive any form of reward.

In the situation that the feedback is not positive, the customer is presented with an online form to submit feedback or suggestions to the business, at step 320. The online form is provided by the review management service. The business is then notified of the negative feedback review prior to the review being sent to a review webpage, at step 322. The business being notified of the negative feedback review prior to being submitted online, allows the business to manage or counter the negative feedback review in many different ways. The business may choose to contact the customer directly. The business may also choose to improve aspects suggested by the customer. Then a customer receives notification of a reward thr submitting a feedback review, at step 318. Providing a customer with a reward for the business even in the situation of a negative feedback review, provides another opportunity for a business to leave a positive impression on the customer.

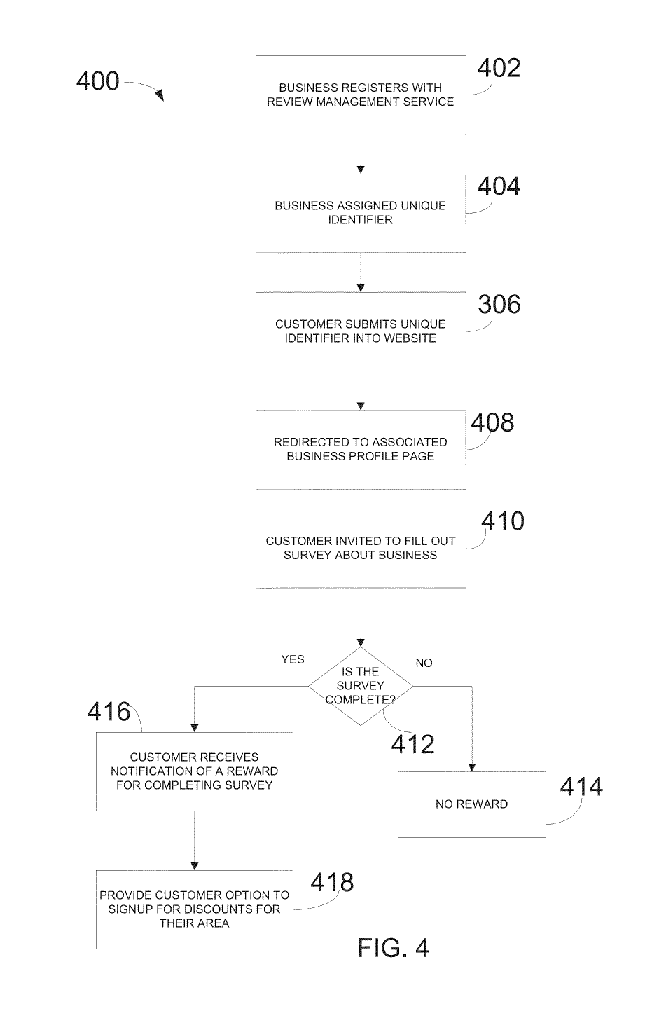

Now referring to FIG. 4, which illustrates an exemplary process for a business to provide incentives to customers to promote positive feedback reviews, in accordance with embodiments of the invention. The incentive for FIG. 4 is for the customer to fill out a survey about the business. The business registers with a review management service, at step 402. The business is then assigned a unique identifier, at step 404. The customer submits the unique identifier into the review management service's webpage, at step 406. The customer is then redirected to the associated business profile page, at step 408.

The customer is then invited to fill out a survey about the business, at step 410. The review management service determines if the survey is filled out completely, at step 412. If the survey is not filled out completely, the customer does not receive a reward or incentive (414). If the survey is filled out completely, then the customer receives a notification of a reward or incentive for filling out the survey (416). At step 418, the customer is presented with the option to signup for discounts in the customer's area. Providing incentives for a customer to fill out a survey about a business may also help to manage or counteract negative feedback reviews before they happen. A survey also might be filled out for a specific employee or entity within the business if a unique entity identifier is provided.

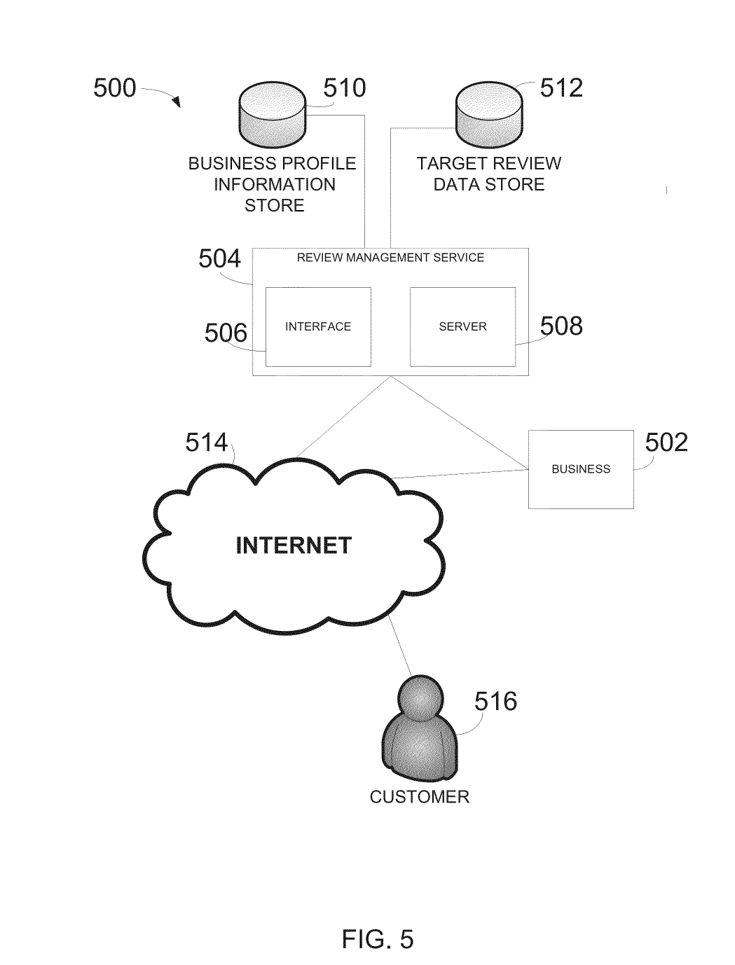

FIG. 5 illustrates an exemplary feedback review management system in accordance with embodiments of the invention. As shown in FIG. 5, the system 500 includes a business 502, review management service 504, business profile information store 510, target review data store 512, the Internet 514, and a customer 516. The business 502 illustrated in FIG. 5 does not represent only one specific business but may represent a plurality of businesses that might register with the review management service 504. The customer 516 also may represent a plurality of different customers.

The review management service 504 may also include acs interface 506 and a server 508. The interface 506 may facilitate the communication between the customer 516 and the server 508. The interface 506 and the server 508 are communicatively connected to transmit information between them. The interface 506 may also display the webpage for the review management service 504, the business profile page and the entity profile page. The interface 506 may also be responsible for providing the notifications to the businesses, customers, etc. The business profile information store 510 may responsible for storing information pertaining to each business profile, such as profile page information, business category information, entity profile page information, etc. The business profile information store 510 may be, but is not limited to, a server, a database, part of the review management service 504, or part of the server 508. The business profile information store 510 is communicatively coupled to the review management service 504. The business profile information store 510 may also be communicatively coupled to the interface 506 and/or the server 508.

The target review data store 512 may be responsible for storing information relating to categorizing and organizing information about different review pages and selecting the relevant review pages for positive feedback review submission. The target review data store 512 may be, but is not limited to, a server, a database, part of the review management service 504, or part of the server 508. The target review data store 512 is communicatively coupled to the review management service 504. The target review data store 512 may also be communicatively coupled to the interface 506 and/or the server 508.

The customer 516 may access the webpage provided by the review management service via many different methods, such as mobile application, mobile web browser, web browser, kiosk station at a business location, etc. The webpage provided by the review management service is accessible via a connection through the Internet 514. The business 504 may access the review management service 504 via the webpage of the review management service but the review management service 504 may also provide each business 502 with a management profile for logging in to review activity through the review management service 504 by customers 516.

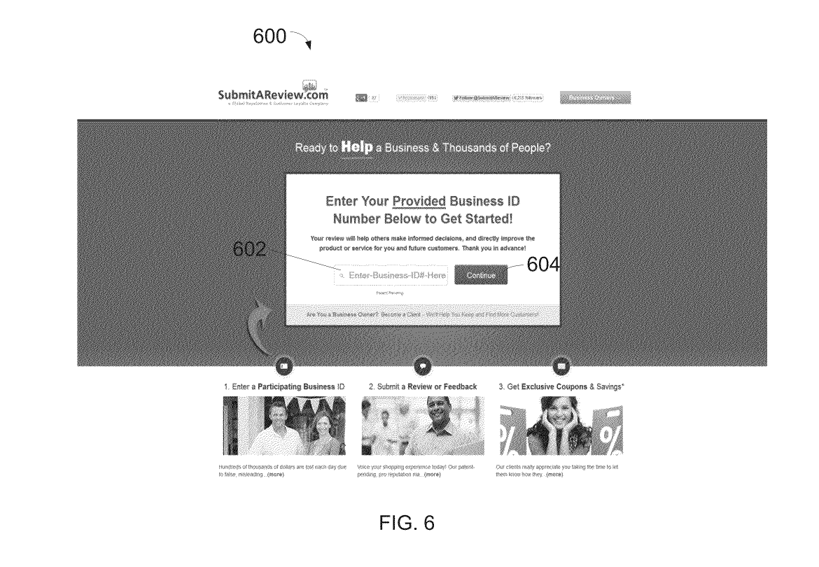

Now referring to FIG. 6, which is an exemplary screenshot 600 of the webpage provided by the review management service. The webpage includes a text field 602 for entering either a unique identifier or unique entity identifier for a business. The webpage might also include links to allow a new business to register with the review management service. The webpage also includes a button 604 for submitting either a unique identifier or a unique entity identifier.

Now referring to FIG. 7, which is an exemplary screenshot of a business profile page. The webpage 700 may include information about the business, such as phone number, webpage, business hours, address, directions, map information, etc. The profile page also includes a link to either take a survey, or leave a feedback review.

Now referring to FIG. 8, which is an exemplary screenshot for a business profile including area for a customer to provide a feedback review. The webpage 800 includes area 802 which illustrates one of the incentives, “Rate Your Experience Below to Receive a ½ OFF Any Service Coupon:” Below 802 is 804 which is an area for a customer to rate their experience with the business. The area of 804 includes four different facial expressions to choose from ranging from very unhappy on the far left to very happy on the far right. The facial expressions may be selectable. This is just one example of the way a customer may indicate whether the feedback review will be a positive or a negative one. Also, webpage 800 may include a reward offer, which includes an example of the type or option a reward might be presented to a customer. The customer might also be presented with the ability to share information or a positive review about a business through the customer's social media. The customer might also receive a reward for sharing the business information.

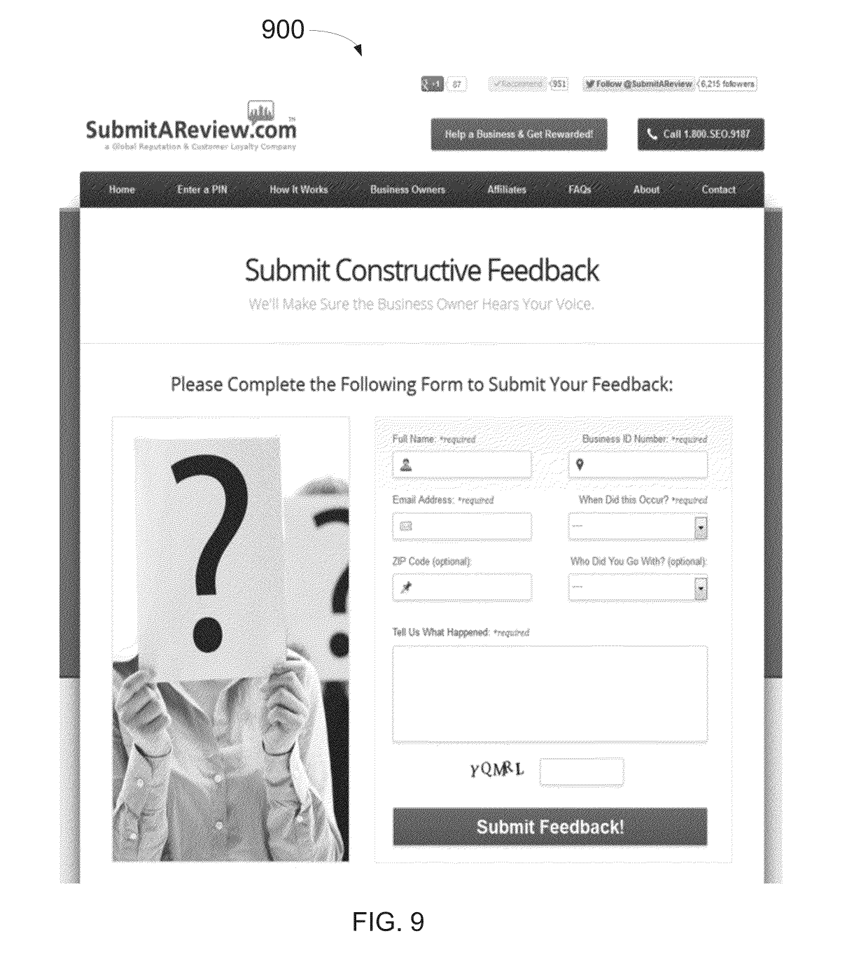

Now referring to FIG. 9, which is an exemplary screenshot of a from to provide comments or suggestions to a business. The webpage 900 illustrates a form that a customer might fill out if they indicated that they wanted to leave a negative feedback review. This form provides useful information for the business to hopefully improve future experiences. This form is just an example of the format and types of questions that may be asked.

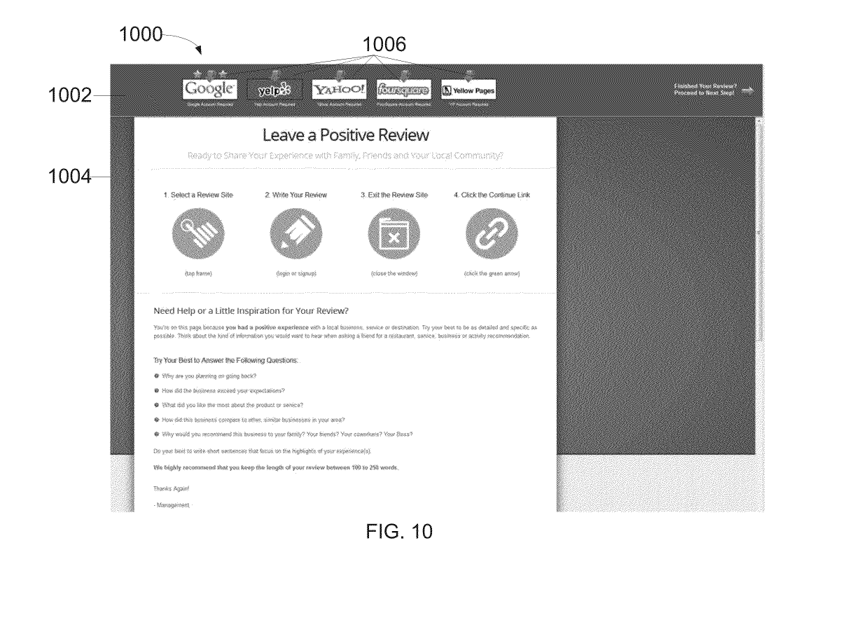

Now referring to FIG. 10, which is an exemplary screenshot for a customer to provide a feedback review inside of a frame with targeted review webpages in accordance with embodiments of the invention. The webpage 1000 may include several parts, such as a top frame 1002, a bottom frame 1004, and/or targeted review webpage options 1006. A customer may select one or more of the targeted review webpages 1006 and the customer is then connected with the targeted review webpage to help increase the businesses' positive reputation. For example if the business is a hotel, the targeted review webpages may include Orbitz, TripAdivsor, Yelp, etc. Once a customer selects one of the targeted review webpages, the customer may view the targeted review webpage inside the bottom frame 1004. By maintaining the top frame 1002, the customer may easily leave multiple positive reviews on different targeted review webpages.

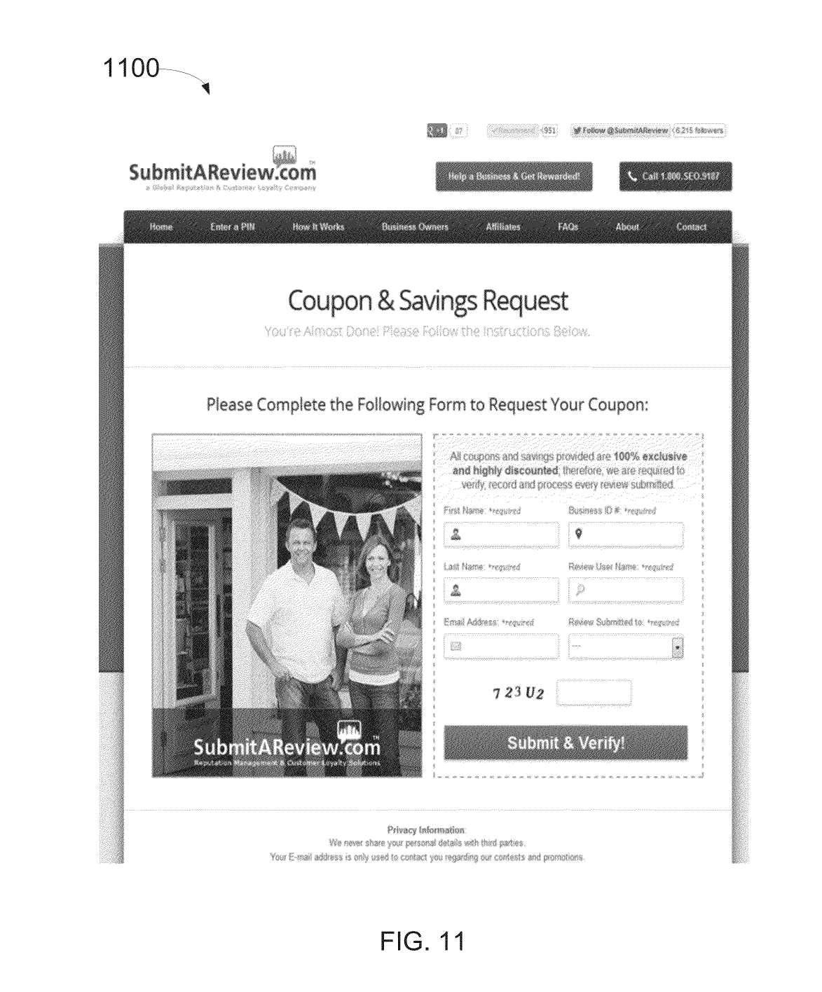

Now referring to FIG. 11, which is an exemplary screenshot of a form to provide a customer the opportunity to receive future communication. As discussed above, the customer may be presented with the webpage 1100 for opportunity to receive future communications from the review management service, the business or other area businesses. The future communication may include, but is not limited to, a newsletter, coupons, discounts, sales, events, promotions and other general information. The future communication may also be in different forms. For example, the communication may be distributed through email, home address, etc.

Based on the foregoing, illustrative embodiments have been described to provide an overall understanding of the systems and methods for managing enterprise content. One or more examples of the illustrative embodiments are shown in the drawings. The disclosed systems and methods can be adapted and modified to provide systems and methods for other applications, and that other additions and modifications can be made to the disclosed systems and methods without departing from the scope of the present disclosure. For example, features of the illustrative embodiments can be combined, separated, interchanged, and/or re-arranged to generate other embodiments. Such modifications and variations are intended to be included within the scope of the present disclosure.

The systems and methods described herein are not limited to a hardware or software configuration; they can find applicability in many computing or processing environments. The systems and methods can be implemented in hardware or software, or in a combination of hardware and software. The systems and methods can be implemented in one or more computer-readable storage medium (including computer programs), in which a medium/computer program can be understood to include one or more processor-executable instructions. The computer programs can execute on one or more programmable processors, and can be stored on one or more storage media readable by the processor, comprising volatile and non-volatile memory and/or storage elements.

The computer programs can be implemented in high level procedural or object oriented programming language to communicate with a computer system. The computer programs can also be implemented in assembly or machine language. The language can be compiled or interpreted.

The computer programs can be stored on a storage medium or a device (e.g., compact disk (CD), digital video disk (DVD), magnetic tape or disk, internal hard drive, external hard drive, random access memory (RAM), redundant array of independent disks (RAID), or removable memory device) that is readable by a general or special purpose programmable computer for configuring and operating the computer when the storage medium or device is read by the computer to perform the methods described herein.

Unless otherwise provided, references herein to memory can include one or more processor-readable and -accessible memory elements and/or components that can be internal to a processor-controlled device, external to a processor-controlled device, and/or can be accessed via a wired or wireless network using one or more communications protocols, and, unless otherwise provided, can be arranged to include one or more external and/or one or more internal memory devices, where such memory can be contiguous and/or partitioned based on the application.

Unless otherwise provided, references herein to a/the processor and a/the microprocessor can be understood to include one or more processors that can communicate in stand-alone and/or distributed environment(s) and can be configured to communicate via wired and/or wireless communications with one or more other processors, where such one or more processor can be configured to operate on one or more processor-controlled devices that can include similar or different devices. Use of such processor and microprocessor terminology can be understood to include a central processing unit, an arithmetic logic unit, an application-specific integrated circuit, and/or a task engine, with such examples provided for illustration and not limitation.

Unless otherwise provided, use of the articles “a” or “an” herein to modify a noun can be understood to include one or more than one of the modified noun.

While the systems and methods described herein have been shown and described with reference to the illustrated embodiments, those of ordinary skill in the art will recognize or be able to ascertain many equivalents to the embodiments described herein by using no more than routine experimentation. Such equivalents are encompassed by the scope of the present disclosure and the appended claims. Accordingly, the systems and methods described herein are not to be limited to the embodiments described herein, can include modifications and variations thereof as are contemplated to be within the scope of the appended claims.

What is claimed is:

1. A method for a business to manage negative feedback reviews submitted on a public review webpage by a customer, the method comprising:
registering a business with a review management service;
assigning a unique identifier to the business, where the unique identifier is associated with a business profile webpage provided by the review management service;
submitting, by a customer, the unique identifier within a webpage provided by the review management service;
after receiving the unique identifier, redirecting the customer to a profile webpage unique to the business associated with the submitted unique identifier;
submitting, by the customer, a feedback review for the business; and
in response to receiving the feedback review from the customer, providing, to the business, information relating to the customer feedback from the review management service to enable the business to counter or manage negative feedback.

2. The method of claim 1, wherein the review management service receives the negative feedback review from a customer and subsequently notifies the business of the negative feedback review prior to being submitted to a public review webpage.

3. The method of claim 1, wherein the provided information enables identifies an employee or entity of the business as a source of customer dissatisfaction in a negative review so that the business can take appropriate action against the employee or entity to prevent further negative reviews.

4. The method of claim 3, which further comprises identifying at least one or more employees or entities within the business that caused the customer to generate a negative review by:
assigning a unique entity identifier for at least each of the one or more identified employees or entities within the business;
submitting, by the customer, the unique entity identifier within the webpage provided by the review management service;
after receiving the unique entity identifier, redirecting the customer to a profile webpage unique to an entity within the business associated with the submitted unique entity identifier;
submitting, by the customer, a feedback review specific to the identified entity within the business; and
receiving, by the business, notification of the feedback review specific to the identified entity to evaluate different entities within the business.

5. The method of claim 1, wherein the provided information enables the company to counter negative feedback by providing a reward to a customer that provides a positive review.

6. The method of claim 5, wherein the reward includes a discount or a coupon related to the business.

7. The method of claim 1, wherein the providing of the reward follows a request for inviting the customer to complete a survey about the business, wherein the customer receives the reward after completing the survey.

8. A system for enabling a business to manage negative feedback reviews submitted on a public review webpage by a customer, the system comprising:
a review management service that includes an interface component and a server, wherein the review management service is configured to electronically perform the steps of:
registering a business with a review management service;
assigning a unique identifier to the business, where the unique identifier is associated with a business profile webpage provided by the review management service;
receiving a submission from the customer of the unique identifier within a webpage provided by the review management service;
after receiving the unique identifier, redirecting the customer to a profile webpage unique to the business associated with the submitted unique identifier;
receiving a submission of a feedback review for the business from the customer; and
in response to receiving the feedback review from the customer; providing, information relating to the customer feedback from the review management service to enable the business to counter or manage negative feedback.

9. The system of claim 8, wherein the review management service receives the negative feedback review from a customer and subsequently notifies the business of the negative feedback review prior to being submitted to a public review webpage.

10. The system of claim 8, wherein the provided information enables identifies an employee or entity of the business as a source of customer dissatisfaction in a negative review so that the business can take appropriate action against the employee or entity to prevent further negative reviews.

11. The system of claim 10, wherein the system identifies at least one or more employees or entities within the business that caused the customer to generate a negative review by:
assigning a unique entity identifier for at least each of the one or more identified employees or entities within the business;
receiving a submission of the unique entity identifier from the customer within the webpage provided by the review management service;
after receiving the unique entity identifier, redirecting the customer to a profile webpage unique to an entity within the business associated with the submitted unique entity identifier;
receiving a submission from the customer of a feedback review specific to the identified entity within the business; and
receiving, by the business, notification of the feedback review specific to the identified entity to evaluate different entities within the business.

12. The system of claim 8, wherein the provided information enables the company to counter negative feedback by providing a reward to a customer that provides a positive review.

13. The system of claim 12, wherein the reward includes a discount or a coupon related to the business.

14. The system of claim 8, wherein the providing of the reward follows a request for inviting the customer to complete a survey about the business, wherein the customer receives the reward after completing the survey.

15. A non-transitory processor readable medium for enabling a business to manage negative feedback reviews submitted on a public review webpage by a customer, the medium comprising instructions that when executed by a processor causes the processor to perform actions that comprise:
registering a business with a review management service;
assigning a unique identifier to the business, where the unique identifier is associated with a business profile webpage provided by the review management service;
receiving a submission from the customer of the unique identifier within a webpage provided by the review management service;
after receiving the unique identifier, redirecting the customer to a profile webpage unique to the business associated with the submitted unique identifier;
receiving a submission of a feedback review for the business from the customer; and
in response to receiving the feedback review from the customer, providing, to the business, information relating to the customer feedback from the review management service to enable the business to counter or manage negative feedback.

16. The medium of claim 15, wherein the review management service receives the negative feedback review from a customer and subsequently notifies the business of the negative feedback review prior to being submitted to a public review webpage.

17. The medium of claim 15, wherein the provided information enables identifies an employee or entity of the business as a source of customer dissatisfaction in a negative review so that the business can take appropriate action against the employee or entity to prevent further negative reviews.

18. The medium of claim 17, wherein the business identifies at least one or more employees or entities within the business that caused the customer to generate a negative review by:
assigning a unique entity identifier for at least each of the one or more identified employees or entities within the business;
receiving a submission from the customer of the unique entity identifier within the webpage provided by the review management service;
after receiving the unique entity identifier, redirecting the customer to a profile webpage unique to an entity within the business associated with the submitted unique entity identifier;
receiving a submission a feedback review specific to the identified entity within the business from the customer; and
receiving, by the business, notification of the feedback review specific to the identified entity to evaluate different entities within the business.

19. The medium of claim 15, wherein the provided information enables the company to counter negative feedback by providing a reward to a customer that provides a positive review.

20. The medium of claim 19, wherein the reward includes a discount or a coupon related to the business.

21. The medium of claim 15, wherein the providing of the reward follows a request for inviting the customer to complete a survey about the business, wherein the customer receives the reward after completing the survey.
